(19) United States
(12) Patent Application Publication
(10) Pub. No.: US 2015/0025893 A1
(43) Pub. Date: Jan. 22, 2015

(54) IMAGE PROCESSING APPARATUS AND CONTROL METHOD THEREOF

(71) Applicant: SAMSUNG ELECTRONICS CO., LTD., Suwon-si (KR)

(72) Inventors: Sung-woo PARK, Seoul (KR); Yui-yoon LEE, Busan (KR)

(73) Assignee: SAMSUNG ELECTRONICS CO., LTD., Suwon-si (KR)

(21) Appl. No.: 14/230,858

(22) Filed: Mar. 31, 2014

(30) Foreign Application Priority Data
Jul. 17, 2013 (KR) 10-2013-0084082

(51) Int. Cl. G10L 21/06

(52) U.S. Cl. CPC G10L 21/06
USPC 704/275

(57) ABSTRACT

An image processing apparatus and control method are provided. The image processing apparatus includes: a communication interface which is configured to communicably connect to a server; a voice input interface which is configured to receive a speech of a user and generate a voice signal corresponding the speech; a storage which is configured to store at least one user account of the image processing apparatus and signal characteristic information of a voice signal that is designated corresponding to the user account; and a controller which is configured to, in response to an occurrence of a log-in event with respect to the user account, determine a signal characteristic of the voice signal corresponding the speech received by the voice input interface, select and automatically log in to a user account corresponding to the determined signal characteristic from among the at least one user account stored in the storage, and control the communication interface to connect to the server with the selected user account.

### CROSS-REFERENCE TO RELATED APPLICATION

This application claims priority from Korean Patent Application No. 10-2013-0084082, filed on Jul. 17, 2013 in the Korean Intellectual Property Office, the disclosure of which is incorporated herein by reference.

### BACKGROUND

1. Field

Apparatuses and methods consistent with the exemplary embodiments relate to an image processing apparatus which is connected to a server for communication in a network system and a control method thereof, and more particularly, to an image processing apparatus and a control method thereof which allows a user to log in to the server with an account stored in the image processing apparatus.

2. Description of the Related Art

An image processing apparatus processes image signals/image data provided from the outside, according to various image processing operations. The image processing apparatus may display an image on a display panel of its own based on the processed image signal, or may output the processed image signal to another display apparatus including a display panel to display an image by the another display device based on the processed image signal. That is, the image processing apparatus may be devices including a display panel, or devices excluding the display panel as long as the image processing apparatus may process an image signal. The former case may include a television (TV), and the latter case may include a set-top box.

With the development of technology, new functions are being added to the image processing apparatus and functions of the image processing apparatus are expanding. Thus, it is advantageous for the image processing apparatus to receive various services by being connected to a server and clients through a network. However, in receiving a predetermined service from the server, the image processing apparatus logs in to the server with a user account to receive user specific services in many cases even though there are some other cases where the image processing apparatus receives services just by being connected to the server for communication.

To log in with a specific account, a user inputs an identifier (ID) and a password of the account by pressing characters or numbers of a character input device such as a remote controller. However, such method may cause inconvenience since a user should input all of characters or numbers one by one.

### SUMMARY

According to an aspect of an exemplary embodiment, there is provided an image processing apparatus including: a communication interface which is configured to communicably connect to a server; a voice input interface which is configured to receive a speech of a user and generate a voice signal corresponding the speech; a storage which is configured to store at least one user account of the image processing apparatus and signal characteristic information of a voice signal that is designated corresponding to the user account; and a controller which is configured to, in response to an occurrence of a log-in event with respect to the user account, determine a signal characteristic of the voice signal corresponding the speech received by the voice input interface, select and automatically log in to a user account corresponding to the determined signal characteristic from among the at least one user account stored in the storage, and control the communication interface to connect to the server with the selected user account.

The signal characteristic of the voice signal may include at least one of a frequency, a speech time and an amplitude.

The controller may request the user to input speech a number of times in response to the occurrence of the log-in event, and the signal characteristic may comprise a number code that is extracted on the basis of a frequency per speech input, and a speech time per speech input of the voice signal that is generated by the user's speech.

The controller may provide a user with a plurality of security levels for a user to select one of the security levels when the signal characteristic of the voice signal corresponding to the user account is initially set with respect to the image processing apparatus, each of the security levels corresponding to a different number of times to which to input the speech, and in response to the occurrence of the log-in event, the controller may request the user to input speech a number of times corresponding to the security level of the user account.

The number of times for input of the speech increases as the security level becomes higher.

In response to the number of times that speech is input during a preset time starting from the requested time being less than the number of times corresponding to the security level, the controller may request the user to speak again.

When the voice signal that is generated when a user speaks once includes different frequencies in a plurality of time sections of the generated voice signal, the controller may determine as the signal characteristic a frequency of the voice signal for a period of time from an end of the speech to a time prior to a preset time.

The image processing apparatus may further include a display, wherein the controller may display on the display, in real-time, information of the signal characteristic of the voice signal that is being generated by a user's speech.

According to an aspect of another exemplary embodiment, there is provided a control method of an image processing apparatus, the control method including: storing at least one user account of the image processing apparatus, and signal characteristic information of a voice signal that is designated corresponding to the user account; in response to the occurrence of a log-in event with respect to the user account, inputting a speech of a user; determining a signal characteristic of a voice signal that is generated from the speech; and selecting a user account corresponding to the determined signal characteristic from among the stored at least one user account and automatically logging in to the selected user account.

The signal characteristic of the voice signal may include at least one of a frequency, a speech time and an amplitude.

The inputting the user's speech may comprise requesting a user to speak a number of times in response to the occurrence of the log-in event, and the signal characteristic may comprise a number code that is extracted on the basis of a frequency per speech input and a speech time per speech input of the voice signal that is generated by the user's speech.

The storing may comprise providing a user with a plurality of security levels for a user to select one of the security levels when the signal characteristic of the voice signal corresponding to the user account is initially set with respect to the image processing apparatus, each of the security levels corresponding to a different number of times to which to input the speech, and in response to the occurrence of the log-in event, requesting the user to input speech a number of times corresponding to the security level of the user account.

The number of times for input of the speech increases as the security level becomes higher.

The determining the signal characteristic may comprise, in response to the number of times that speech is input during a preset time starting from the requested time being less than the number of times corresponding to the security level, requesting the user to speak again.

The determining the signal characteristic comprises, when the voice signal that is generated when a user speaks once includes different frequencies in a plurality of time sections of the generated voice signal, determining as the signal characteristic a frequency of the voice signal for a period of time from an end of the speech to a time prior to a preset time.

The determining the signal characteristic comprises displaying, in real-time, information of the signal characteristic of the voice signal that is being generated by the user's speech.

According to an aspect of another exemplary embodiment, there is provided an image processing apparatus including: a voice input interface which is configured to receive a voice input; a storage which is configured to store a plurality of user accounts, and for each user account, signal characteristic information of a voice signal that corresponds to the user account; and a controller which is configured to, in response to receiving a voice input through the voice input interface, determine a signal characteristic of the voice input, selects a user account from among the plurality of user accounts based on the signal characteristic, and automatically log in to the selected user account.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of an image processing apparatus which is included in a system, according to an exemplary embodiment;

FIG. 2 illustrates an example of logging in to a server with an account that is stored in the display apparatus of FIG. 1;

FIG. 3 is a flowchart showing a control method of the display apparatus of FIG. 1, according to an exemplary embodiment;

FIG. 4 illustrates an example of a waveform of a voice signal that is made by a user when the user speaks once in the display apparatus of FIG. 1;

FIG. 5 illustrates an example of a waveform of a voice signal that is made by a user when the user speaks four times in the display apparatus of FIG. 1;

FIG. 6 illustrates an example of a user interface (UI) image that is provided by the display apparatus of FIG. 1 to initially register a voice signal corresponding to an account;

FIG. 7 illustrates an example of a UI image that is provided when a user selects a low security level in response to the UI image of FIG. 6;

FIG. 8 illustrates an example of a UI image that is provided when a user selects a high security level in response to the UI image of FIG. 6;

FIG. 9 illustrates an example of a UI image that is provided when a user makes a speech less than the number of speeches requested by the UI image in FIG. 8;

FIG. 10 illustrates an example of blocks with a plurality of different frequencies in a voice signal that is made when a user speaks once; and

FIG. 11 illustrates an example of a UI image that is displayed in real-time when a user speaks.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

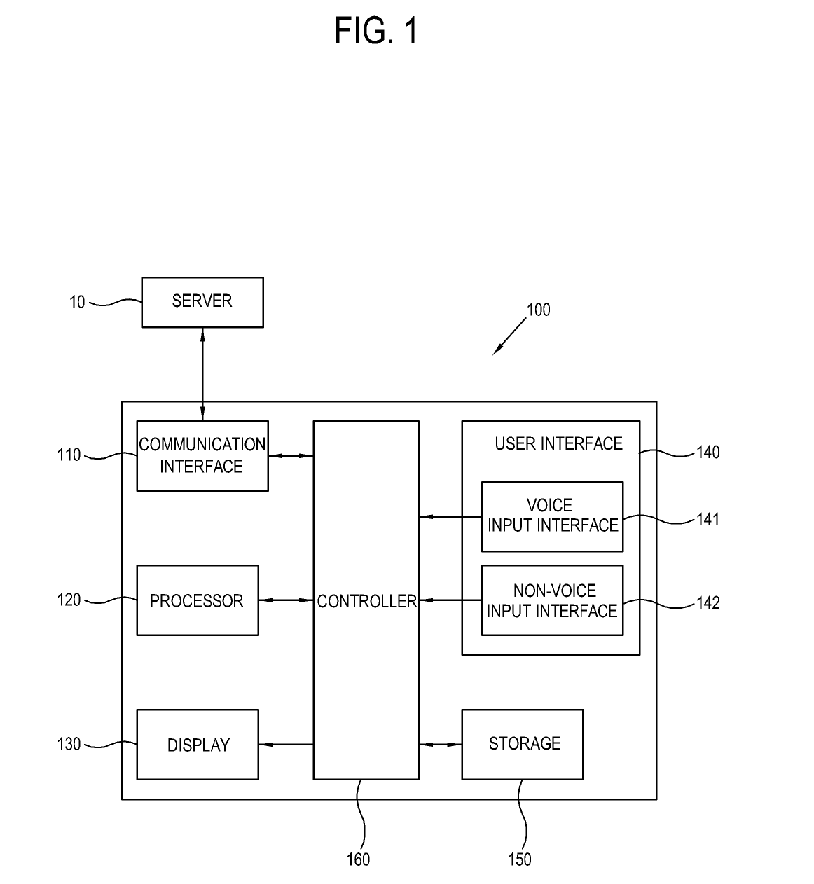

FIG. 1 is a block diagram of an image processing apparatus which is included in a system, according to an exemplary embodiment. The image processing apparatus according to the present exemplary embodiment is a display apparatus which is configured to display an image on its own. However, the spirit of the present exemplary embodiment may also apply to an image processing apparatus which does not display an image on its own. In such a case, the image processing apparatus may be locally connected to an additional external display apparatus to display an image by the external display apparatus.

As shown in FIG. 1, an image processing apparatus 100 according to the present exemplary embodiment receives an image signal from an external image supply source (not shown). The type or characteristics of the image signal which may be received by the image processing apparatus 100 is not limited, and for example, the image processing apparatus 100 may receive a broadcasting signal transmitted by transmission equipment (not shown) of a broadcasting station, and tune the broadcasting signal to display a broadcasting image based thereon.

The image processing apparatus 100 includes a communication interface 110 to communicate with the outside for transmission and reception of data and signals; a processor 120 to process data received by the communication interface 110, according to preset processes; a display 130 which displays an image thereon based on data processed by the processor 120 if the data includes image data; a user interface 140 to perform operations input by a user; a storage 150 to store data and information therein; and a controller 160 to control overall operations of the image processing apparatus 100. The processor 120 may be implemented by one or more microprocessors, and the controller 160 may also be implemented by one or more microprocessors, which may be the same as or different from the one or more microprocessors that implement the processor 120.

The communication interface 110 transmits and receives data for the image processing apparatus 100 to perform interactive communication with an external apparatus such as a server 10. The communication interface 110 is connected to an external apparatus (not shown) locally or through a wide area or local area network in a wired or wireless manner according to a preset communication protocol.

The communication interface 110 may be implemented by individual connection ports or connection modules for each apparatus. The protocol used by the communication interface 110 to be connected to the external apparatus or the external apparatus to which the communication interface 110 is connected is not limited to a single type or form. That is, the communication interface 110 may be embedded in the image processing apparatus 100 or may be added, in whole or in part, as an add-on or dongle to the image processing apparatus 100.

The communication interface 110 transmits and receives signals according to protocols designated for each apparatus connected thereto, and may transmit and receive signals based on an individual connection protocol for each apparatus connected thereto. For example, if image data are transmitted and received by the communication interface 110, the communication interface 110 may transmit and receive image data based on various standards such as radio frequency (RF) signals, Composite/Component video, super video, bluetooth, SCART, high definition multimedia interface (HDMI), DisplayPort, unified display interface (UDI) or wireless HD.

The processor 120 performs various processing operations with respect to data and signals received by the communication interface 110. If image data are received by the communication interface 110, the processor 120 processes the image data and transmits the processed image data to the display 130 to thereby display an image on the display 130 based on the processed image data. If a signal received by the communication interface 110 includes a broadcasting signal, the processor 120 extracts an image, voice data and additional data from the broadcasting signal tuned to a specific channel, and adjusts the image to a preset resolution to display the image on the display 130.

The image processing operations of the processor 120 may include, without limitation, decoding corresponding to an image format of image data, de-interlacing for converting interlace image data into progressive image data, scaling for adjusting image data into a preset resolution, noise reduction for improving a quality of an image, detail enhancement and/or frame refresh rate conversion, etc.

The processor 120 may perform various processes depending on the type and characteristics of data, and the processes that may be performed by the processor 120 are not limited to the image processing operations. Further, the data that may be processed by the processor 120 are not limited to those received by the communication interface 110. For example, if a user's speech is input through the user interface 140, the processor 120 may process the speech according to a preset voice processing operation.

The processor 120 may be implemented as an image processing board (not shown) which is formed by mounting a system-on-chip performing integrated functions or individual chipsets independently performing the aforementioned operations, in a printed circuit board. The processor 120 which is implemented as above may be installed in the image processing apparatus 100.

The display 130 displays an image thereon based on image signals or image data processed by the processor 120. The display 130 may be implemented as various displays including, without limitation, liquid crystal, plasma, light-emitting diode, organic light-emitting diode, surface-conduction electron-emitter, carbon nano-tube, and/or nano-crystal, etc.

The display 130 may further include additional elements. For example, the display 130 as a liquid crystal display, may include a liquid crystal display (LCD) panel (not shown), a backlight (not shown) emitting light to the LCD panel and a panel driving substrate (not shown) driving the LCD panel.

The user interface 140 transmits preset various control commands or information to the controller 160 according to a user's manipulation or input. The user interface 140 generates information from various events, which occur by a user, and transmits the information to the controller 160 according to a user's intention. The events which occur by a user may vary, e.g., may include a user's manipulation, speech and gesture.

The user interface 140 may detect information depending on an inputting manner of the information by a user. Accordingly, the user interface 140 may be classified into a voice input interface 141 and a non-conversational input interface 142.

The voice input interface 141 may be provided to input a user's speech and generate a voice signal corresponding to the user's speech. That is, the voice input interface 141 may be implemented as a microphone, and detects various sounds which are generated from the external environment of the image processing apparatus 100. The voice input interface 141 may generally detect a user's speech, but may also detect other sounds which are generated by various other environmental factors.

The non-voice input interface 142 may be provided to receive a user's input other than by a user's speech. The non-voice input interface 142 may be implemented as various types, e.g., as a remote controller that is separated and spaced from the image processing apparatus 100, or as a menu key or an input panel installed in an external side of the image processing apparatus 100 or as a motion sensor or a camera to detect a user's gesture.

Otherwise, the non-voice input interface 142 may be implemented as a touch screen that is installed in the display 130. In this case, a user may touch an input menu or a user interface (UI) image displayed on the display 130 to transmit a preset command or information to the controller 160.

The storage 150 stores therein various data according to a control of the controller 160. The storage 150 may be implemented as a non-volatile memory such as, for example, a flash memory or a hard-disc drive, to store and preserve data regardless of power supply to a system. The storage 150 is accessed by the controller 160 to read, write, modify, delete, or update data stored therein.

The controller 160 may be implemented as one or more central processing units (CPUs), and upon occurrence of a predetermined event, controls operations of elements of the image processing apparatus 100 including the processor 120. If the event includes a user's speech as an example, the controller 160 controls the processor 120 to process a user's speech if the user's speech is input through the voice input interface 141. For example, when a user speaks a channel number, the controller 160 controls the image processing apparatus 100 to change a channel number to the spoken channel number and display a broadcasting image of the spoken channel number.

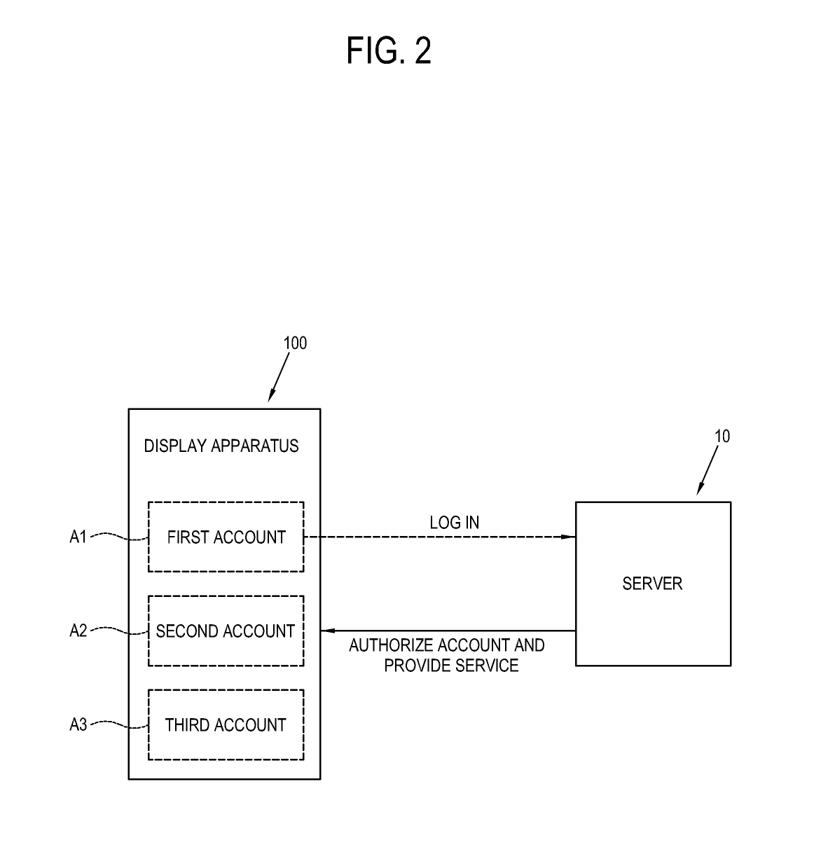

With the foregoing configuration, there may be a case where a user needs to log in to the server 10 (see FIG. 1) with an account that is already stored in the image processing apparatus 100, to obtain a predetermined service from the server 10. Hereinafter, the aforementioned case will be described with reference to FIG. 2.

Turning to FIG. 2, FIG. 2 illustrates an example of logging in to the server 10 by a user with accounts A1, A2 and A3 stored in the image processing apparatus 100.

As shown in FIG. 2, the image processing apparatus 100 stores therein at least one of accounts A1, A2 and A3 which are designated or input in advance by a user. The accounts A1, A2 and A3 may include information pertaining to a user, and are used to provide services specific to a user. The accounts A1, A2, and A3 may be different accounts of a same user, or accounts of different users. The information of a user may include e.g., a user's personal information, program preferences, usage history and other information.

In respect of the accounts A1, A2 and A3, in some exemplary embodiments, for example, in a case where there is only one user, only one of the accounts A1, A2 and A3 may be stored in the image processing apparatus 100. However, in other exemplary embodiments, when there are several users of the image processing apparatus 100, a plurality of accounts A1, A2 and A3, each of which is provided for a different user, may be stored in the single image processing apparatus 100. Alternatively, in yet other exemplary embodiments, individual users may have multiple accounts for each user. In such a case, users may select their own accounts A1, A2 and A3 out of the plurality of accounts A1, A2 and A3 stored in the image processing apparatus 100 and log in to the image processing apparatus 100.

One reason why the accounts A1, A2 and A3 are provided for each user using the single image processing apparatus 100 is that the respective users may be different in age, gender, taste and/or preference, and the details of services desired by users may be different. Additionally, for example, a single user may have multiple accounts which correspond to different services, or to different tastes/preferences for the same service. The server 10 may provide services specific to the respective accounts A1, A2 and A3 depending on the account that is used for the image processing apparatus 100 to log in to the server 10. For example, the server 10 may decide whether to provide adult programs depending on whether a user is an adult or a minor based on personal information in the accounts A1, A2 and A3, or provide weather information of a local area according to local information included in the accounts A1, A2 and A3, or provide recommended program information according to a viewing history of a program that is included in the accounts A1, A2 and A3, etc.

To select the accounts A1, A2 and A3 stored in the image processing apparatus 100 and log in to the accounts by a user, there is a related art method of inputting a predetermined ID and password for the accounts A1, A2 and A3 through a UI image displayed in the image processing apparatus 100. More specifically, the image processing apparatus 100 may display a UI image for a user to input an ID and password to log in to the accounts A1, A2 and A3, and a user may input an ID and password comprising characters and/or numbers by using, for example, a remote controller (not shown) or other character input device (not shown).

However, in such a case, the remote controller (not shown) is manipulated by the user to input characters and/or numbers, and may take a long time to input such ID and password. For example, often the remote controller has only limited keys and thus the user must manipulate multiple keys to input individual characters or numbers serially. Further, a user should repeat the aforementioned input process whenever the user changes the accounts A1, A2 and A3 in the image processing apparatus 100, and/or when the user must renew the credentials of the user, and may feel inconvenience in logging in to the accounts A1, A2 and A3. If the ID and/or password is complicated as often required for security purposes, the inconvenience increases.

Accordingly, the following method is offered according to the present exemplary embodiment.

The storage 150 stores therein at least one user account of the image processing apparatus 100 and signal characteristic information of a voice signal that is designated for respective user accounts. If a log-in event occurs with respect to a user account, the controller 160 determines a signal characteristic of the voice signal that is input by a user's speech, and searches a user account that matches the determined signal characteristic. The controller 160 automatically logs in to the user account that has been searched based on the determined signal characteristic, and is connected to the server 10 with the searched user account.

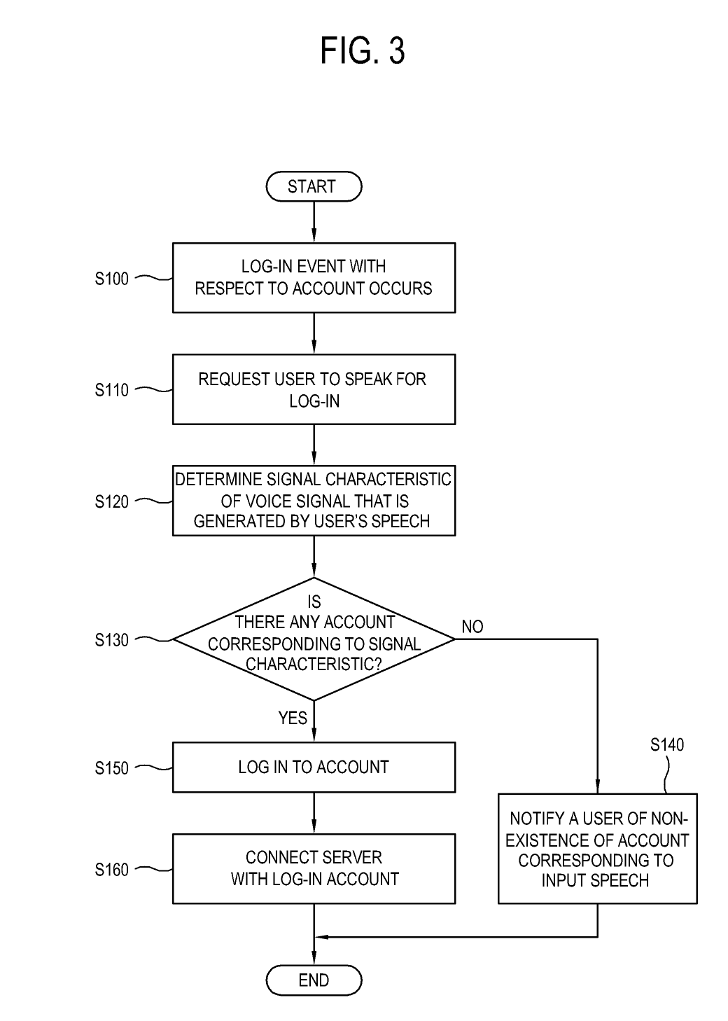

Hereinafter, a control method of the image processing apparatus according to the present exemplary embodiment will be described with reference to FIG. 3.

FIG. 3 is a flowchart showing the control method of the image processing apparatus.

As shown in FIG. 3, a log-in event occurs with respect to a user account (S100). Upon the occurrence of the event, the image processing apparatus 100 requests a user to input speech to log in to an account (S110).

When a user inputs speech in response to the request, the image processing apparatus 100 determines the signal characteristic of a voice signal that has been generated by the user's speech (S120). The image processing apparatus 100 determines whether there is any user account that corresponds to the determined signal characteristic (S130).

If there is no user account that corresponds to the determined signal characteristic out of the stored user accounts, the image processing apparatus 100 notifies a user of the fact that there is no user account corresponding to the input speech (S140). Thereafter, the image processing apparatus 100 may request a user to make a speech again or end the process.

On the other hand, if there is any user account that corresponds to the determined signal characteristic out of the stored user accounts, the image processing apparatus 100 logs in to the corresponding user account (S150). The image processing apparatus 100 is connected to the server 10 with the logged-in user account (S160).

Through the foregoing process, the image processing apparatus 100 automatically logs in to the account according to the user's speech, and provides a user with an easier and more convenient log-in environment than a conventional log-in by inputting an ID and a password.

Since users have different speech structures and speech habits, signal characteristics of voice signals that are generated by users' speeches are different by user. Accordingly, the image processing apparatus 100 may specify users for respective accounts by using signal characteristics of voice signals.

The signal characteristic of a voice signal has various parameters such as frequency, speech time, amplitude, etc., and at least one of such characteristics may be selected and applied in order to determine the signal characteristic. Even though the image processing apparatus 100 is configured to execute a voice command corresponding to a user's speech by analyzing the content of the user's speech input through the voice input interface 141, in the present exemplary embodiment, the image processing apparatus 100 determines the signal characteristic of the voice signal and not the content of the voice, and thus does not take into account the content of the speech. However, alternatively, in other exemplary embodiments, it is possible to also take into account the content of the speech, in order to, for example, distinguish between multiple accounts of a single user. Such an exemplary embodiment increases computational complexity, but in return for providing access to multiple accounts of a single user.

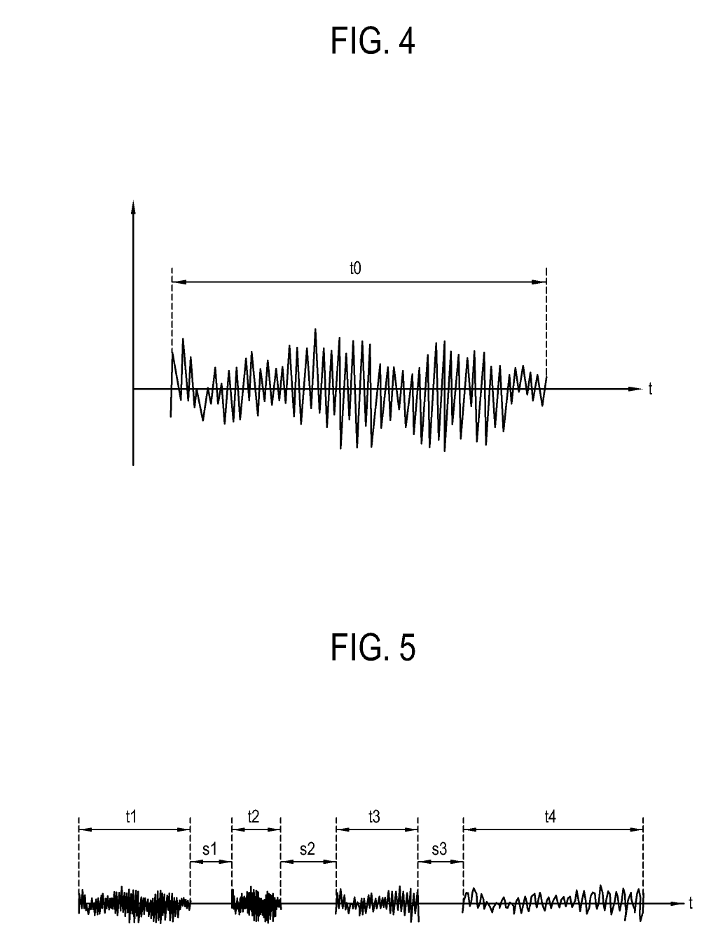

Hereinafter, a method of determining a signal characteristic of a voice signal by the image processing apparatus 100 that is generated by a user's speech is described with reference to FIG. 4.

FIG. 4 illustrates an example of a waveform of a voice signal that is generated when a user speaks once.

As shown in FIG. 4, when a user's speech is input, the image processing apparatus 100 generates a voice signal according to the speech. The voice signal may be shown as a waveform that is formed along a transverse axis of time t.

The voice signal that is generated when a user speaks once has a frequency during its speech time t0. The frequency may be predetermined. Speech time and frequency of voice signals for respective users differ by speech conditions of such respective users. Thus, the image processing apparatus 100 may determine the speech time and frequency of the voice signal that is generated when a user speaks once, and may select a user account corresponding to the determined value.

In the present exemplary embodiment, both the frequency and speech time of the voice signal are considered in determining the signal characteristic of the voice signal, but in other exemplary embodiments only one of the frequency and the speech time may be otherwise considered. However using only one of the frequency and the speech time tends to reduce the accuracy, and thus in the present exemplary embodiment, both the frequency and speech time are considered. Of course, in other exemplary embodiments, additional signal characteristics other than the frequency and speech time may be considered.

In the case in which it is difficult to determine the user account considering only the frequency and speech time, the following method may be used.

FIG. 5 illustrates an example of a waveform of a voice signal that is generated when a user speaks four times, i.e. multiple times.

As shown in FIG. 5, the case where a user speaks n times, e.g., four times, is considered in the present exemplary embodiment. The image processing apparatus 100 generates a voice signal according to a user's speech, and the voice signal is shown as a first block for a first speech that is made during a time t1, a second block for a second speech that is made during a time t2, a third block for a third speech that is made during a time t3, and a fourth block for a fourth speech that is made during a time t4 of a time domain.

A section s1 between the first and second blocks, a section s2 between the second and third blocks and a section s3 between the third and fourth blocks, all of which show substantially no waveform of the voice signal or a suitably low waveform (e.g., background noise, etc.) so as to be discriminated from the user's voice, are mute sections during which a user effectively makes no speech.

The image processing apparatus 100 may designate levels, e.g., designate 100 Hz each, with respect to frequencies of respective voice sections. For example, the image processing apparatus 100 may designate a frequency of approximately 100 Hz as a level 1, designate a frequency of approximately 200 Hz as a level 2, and designate a frequency of approximately 900 Hz as a level 3.

The image processing apparatus 100 may designate values by seconds for the speech time of respective vocal blocks. For example, the image processing apparatus 100 may designate 3 as the speech time of the first block when the speech time of the first block is approximately 3 seconds.

In the foregoing manner, the image processing apparatus 100 may extract a number code of “(frequency, speech time)” for a single vocal block. For example, if a frequency and a speech time of the first block are 500 Hz and 3 seconds, respectively, the image processing apparatus 100 extracts a number code of (5,3) from the first block.

Similarly, the image processing apparatus 100 may extract number codes from the other vocal blocks, and extract a final number code by arranging the extracted number codes. For example, the image processing apparatus 100 may extract number codes of (5, 3), (6, 1), (3, 2) and (4, 4) from a voice signal in the illustrative example shown in FIG. 5.

A user account which is stored in the image processing apparatus 100 is mapped with a number code as above, and the image processing apparatus 100 may select a user account corresponding to a final number code and log in to the user account when the final number code is extracted from a voice signal.

The image processing apparatus 100 may also adjust a length of the code. The code extracted from a voice signal becomes longer in proportion to the number of a user's speech. If the code extracted from a voice signal is long, a user may feel more inconvenience, but the security is relatively stronger. If the code extracted from a voice signal is short, a user may feel more convenience, but the security is relatively weaker.

Accordingly, the image processing apparatus 100 may provide different setup environments according to a security level when a user initially sets up a signal characteristic of a voice signal corresponding to a user account. This will be described hereinafter.

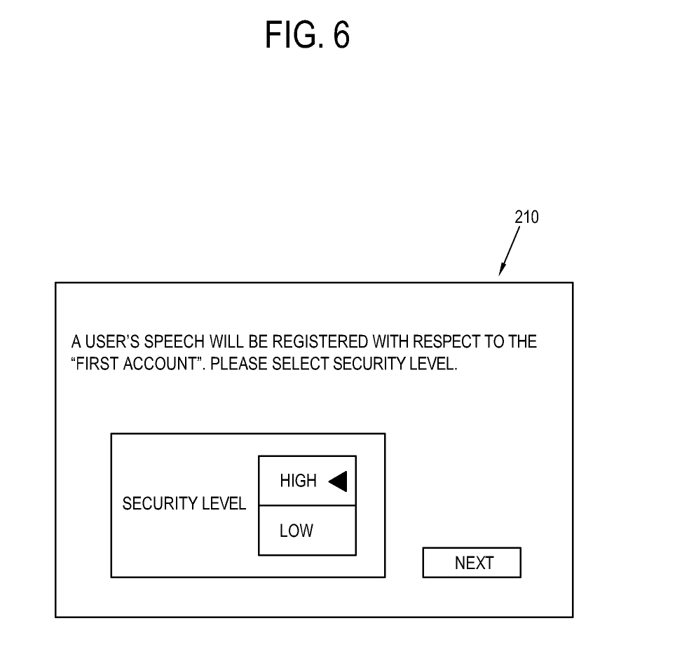

FIG. 6 illustrates an example of a UI image 210 that is provided for the image processing apparatus 100 to initially register a voice signal corresponding to an account.

As shown in FIG. 6, when a user selects an option to initially register speech with respect to a “first account” out of a plurality of user accounts stored in the image processing apparatus 100, the image processing apparatus 100 displays the UI image 210 used to initially register the user's speech.

The UI image 210 includes a request which is made for a user to select a security level prior to the registration of the speech. In the present exemplary embodiment, there are two cases of a high security level and a low security level, but the number is not limited to two and in other exemplary embodiments there may be three or more options.

A security level indicated as “high” denotes that a code extracted from a voice signal generated when a user makes a speech is relatively long, i.e., that the number of a user's speech used for logging in to an account is relatively large. On the contrary, a security level indicated as “low” denotes that a code extracted from a voice signal generated when a user makes a speech is relatively short, i.e., that the number of a user's speech used for logging in to an account is relatively small.

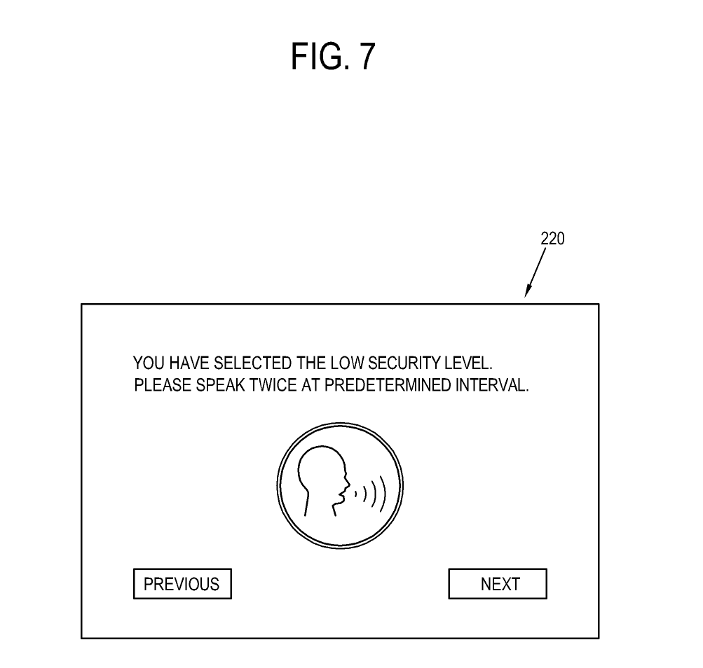

FIG. 7 illustrates an example of a UI image 220 that is provided when a user selects a low security level in FIG. 6.

As shown in FIG. 7, when a user selects a low security level from the UI image 210 in FIG. 6, the image processing apparatus 100 displays a UI image 220 corresponding to the low security level. The UI image 220 may be preset.

The UI image 220 displays a message notifying the user that the user has selected the low security level at a previous stage, and requesting the user to input speech the number of times that is set corresponding to the low security level, e.g., twice. While the UI image 220 is displayed, a user speaks twice, and the image processing apparatus 100 generates and analyzes a voice signal based on the user's speech.

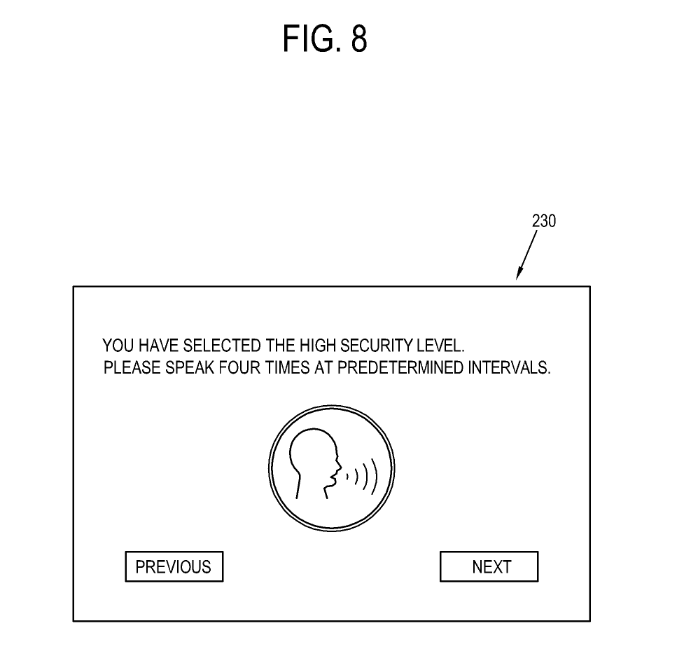

FIG. 8 illustrates an example of a UI image 230 that is provided when a user selects a high security level in FIG. 6.

As shown in FIG. 8, if a user selected the high security level from the UI image 210 in FIG. 6, the image processing apparatus 100 displays a preset UI image 230 corresponding to the high security level.

The UI image 230 displays a message indicating that the user has selected the high security level at a previous stage, and requesting a user to input speech the number of times that is set corresponding to the high security level, e.g., four times. While the UI image 230 is displayed, a user speaks four times, and the image processing apparatus 100 generates and analyzes a voice signal based on the user's speech.

That is, when the high security level is selected, the number of times the user speaks is larger than the number of times when the low security level is selected. The image processing apparatus 100 may provide a user with different log-in environments according to the initially set security level upon occurrence of future log-in events.

There may be a case in which the number of times the user inputs speech is smaller than the number of times requested when the user speaks while the UI image 220 in FIG. 7 or the UI image 230 in FIG. 8 is displayed.

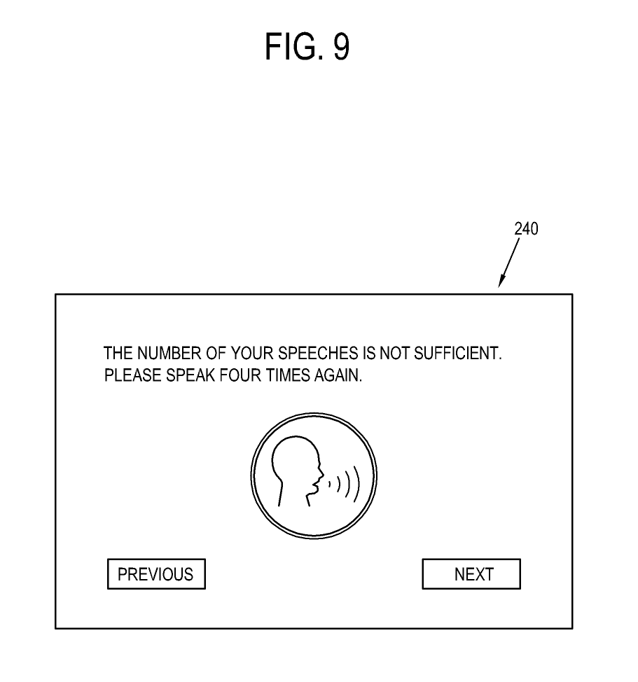

FIG. 9 illustrates an example of a UI image 240 that is provided when a user speaks less than the number of times requested by the UI image 230 in FIG. 8.

As shown in FIG. 9, when a user selects a high security level and the UI image 230 as in FIG. 8 requests a user to speak four times, the user might speak fewer times, e.g., only three times, than requested. If a fourth speech is not input a predetermined time after a user inputs a third speech, the image processing apparatus 100 may determine that a user spoke only three times.

Then, the image processing apparatus 100 displays the UI image 240 shown in FIG. 9 requesting the user to speak four times again since the number of times the user has spoken is less than requested. Then, a user may speak four times again while the UI image 240 is displayed, and the image processing apparatus 100 generates and analyzes a voice signal based on the speech.

There may be a case where a user speaks five times, which is more than four times as requested. In such a case, the display apparatus generates a voice signal based on the four speeches that were made initially, and does not include the fifth speech to the voice signal. Alternatively, in other exemplary embodiments, it is possible to generate the voice signal based on the number of speeches input.

In the foregoing manner, the image processing apparatus 100 may provide a user with different log-in environments by security level.

There may be a case where a voice signal that is generated when a user speaks once has two or more frequencies rather than a uniform frequency. A method of resolving the foregoing problem will be described hereinafter.

People do not always make a sound in a desired frequency due to their physical characteristics. The human vocal cord does not always make sound in an identical frequency unlike a machine, and there may be a block which shows a plurality of frequencies in a voice signal that is generated when a user speaks once.

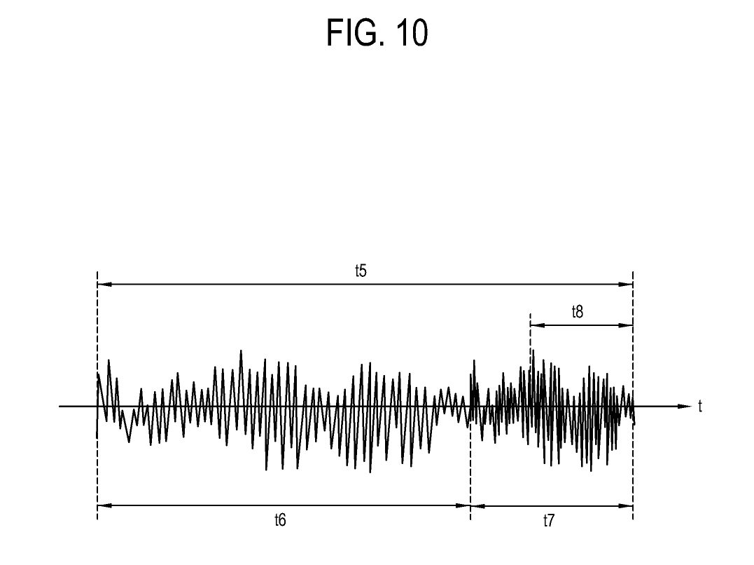

FIG. 10 illustrates an example of a block which shows a plurality of different frequencies in a voice signal that is generated when a user speaks once.

As shown therein, a voice signal that is generated when a user speaks once has temporal blocks t6 and t7 which have different frequencies in a block of time t5. That is, if frequencies of a block t6 and a block t7 are f1 and f2, respectively, f1 and f2 have different values.

Given human speech behavior, it is not easy for people to speak in a desired frequency in the beginning of their speech, but it is relatively easier for people to speak in a desired frequency in a later part of the speech.

Taking into account such fact, the image processing apparatus 100 extracts a sample of a voice signal for a period from an end of the speech to a time prior to a time t8, and decides that a frequency of the voice signal extracted as a sample is the frequency of the voice signal. The time t8 may be preset. A width of the block t8 may be set to be smaller than a block t7 that is obtained through a test.

Even when a user does not speak in a consistent frequency when the user speaks once, the image processing apparatus 100 may obtain a result which fully reflects a user's intention for such speech.

Unlike the case where a user inputs a character and/or a number by using a remote controller (not shown), a user's speech input is made by using the physical organ that is not easy to finely control as intended by a user. In such a case, it is not easy to determine a frequency and a speech time of a voice made currently by a user. This may be addressed by the method below.

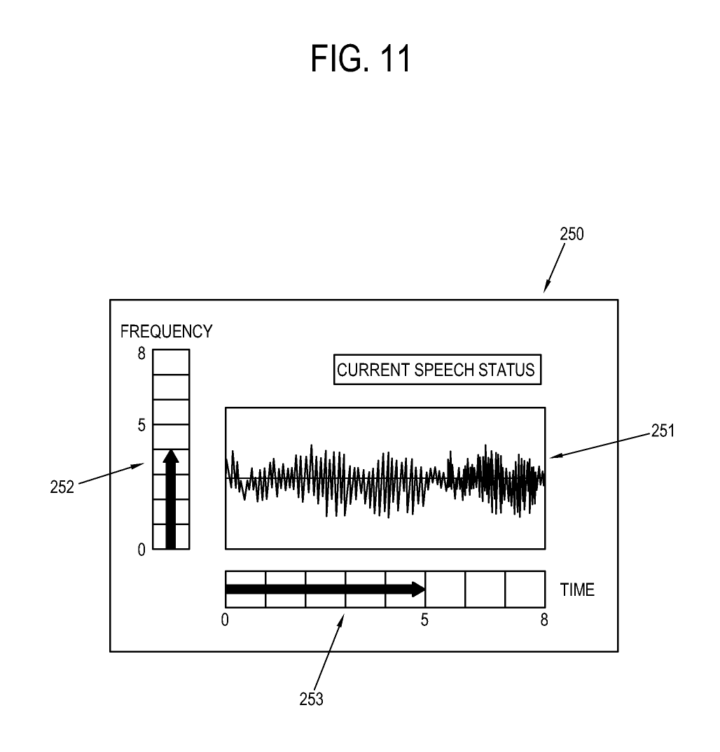

FIG. 11 illustrates an example of a UI image 250 that is displayed in real-time when a user speaks.

As shown in FIG. 11, the image processing apparatus 100 displays a UI image 250 showing in real-time a status of a voice signal that is generated by a user's current speech.

The UI image 250 shows a waveform 251 of a voice signal that is generated by a user's current speech, and a frequency 252 and a speech time 253 of the voice signal. In some exemplary embodiments, the waveform 251 of the voice signal might not be included in the UI image 250.

In the UI image 250, the frequency 252 and the speech time 253 of the voice signal may be shown as a level meter as in the present exemplary embodiment, or may be shown as, for example, numbers and/or graphs, etc.

The image processing apparatus 100 displays in real-time the UI image 250 when a user speaks, and enables a user to easily determine status information of the voice signal that is generated by the current speech.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. An image processing apparatus comprising:
a communication interface which is configured to communicably connect to a server;
a voice input interface which is configured to receive a speech of a user and generate a voice signal corresponding the speech;
a storage which is configured to store at least one user account of the image processing apparatus and signal characteristic information of a voice signal that is designated corresponding to the user account; and
a controller which is configured to, in response to an occurrence of a log-in event with respect to the user account, determine a signal characteristic of the voice signal corresponding the speech received by the voice input interface, select and automatically log in to a user account corresponding to the determined signal characteristic from among the at least one user account stored in the storage, and control the communication interface to connect to the server with the selected user account.

2. The image processing apparatus according to claim 1, wherein the signal characteristic of the voice signal comprises at least one of a frequency, a speech time and an amplitude.

3. The image processing apparatus according to claim 2, wherein the controller is configured to request the user to input speech a number of times in response to the occurrence of the log-in event, and
the signal characteristic comprises a number code that is extracted based on a frequency per speech input, and a speech time per speech input of the voice signal that is generated by the speech.

4. The image processing apparatus according to claim 3, wherein the controller is configured to provide the user with a plurality of security levels for the user to select one of the security levels when the signal characteristic of the voice signal corresponding to the user account is initially set with respect to the image processing apparatus, each of the security levels corresponding to a different number of times to which to input the speech, and in response to the occurrence of the log-in event, the controller is configured to request the user to input speech a number of times corresponding to the security level of the user account.

5. The image processing apparatus according to claim 4, wherein the number of times for input of the speech increases as the security level becomes higher.

6. The image processing apparatus according to claim 3, wherein, in response to the number of times that speech is input during a preset time starting from the requested time being less than the number of times corresponding to the security level, the controller is configured to request the user to speak again.

7. The image processing apparatus according to claim 1, wherein when the voice signal that is generated when a user speaks once includes different frequencies in a plurality of time sections of the generated voice signal, the controller determines as the signal characteristic a frequency of the voice signal for a period of time from an end of the speech to a time prior to a preset time.

8. The image processing apparatus according to claim 1, further comprising a display,
wherein the controller is configured to control the display to display, in real-time, information of the signal characteristic of the voice signal corresponding to the speech.

9. A control method of an image processing apparatus, the control method comprising:
storing at least one user account of the image processing apparatus, and signal characteristic information of a voice signal that is designated corresponding to the user account;
in response to occurrence of a log-in event with respect to the user account, inputting a speech of a user;
determining a signal characteristic of a voice signal that is generated from the speech; and
selecting a user account corresponding to the determined signal characteristic from among the stored at least one user account and automatically logging in to the selected user account.

10. The control method according to claim 9, wherein the signal characteristic of the voice signal comprises at least one of a frequency, a speech time and an amplitude.

11. The control method according to claim 10, wherein the inputting the speech comprises requesting a user to speak a number of times in response to the occurrence of the log-in event, and
the signal characteristic comprises a number code that is extracted based on a frequency per speech input and a speech time per speech input of the voice signal that is generated from the speech.

12. The control method according to claim 11, wherein the storing comprises providing the user with a plurality of security levels for the user to select one of the security levels when the signal characteristic of the voice signal corresponding to the user account is initially set with respect to the image processing apparatus, each of the security levels corresponding to a different number of times to which to input the speech, and in response to the occurrence of the log-in event, requesting the user to input speech a number of times corresponding to the security level of the user account.

13. The control method according to claim 12, wherein the number of times for input of the speech increases as the security level becomes higher.

14. The control method according to claim 11, wherein the determining the signal characteristic comprises, in response to the number of times that speech is input during a preset time starting from the requested time being less than the number of times corresponding to the security level, requesting the user to speak again.

15. The control method according to claim 9, wherein the determining the signal characteristic comprises, when the voice signal that is generated when a user speaks once includes different frequencies in a plurality of time sections of the generated voice signal, determining as the signal characteristic a frequency of the voice signal for a period of time from an end of the speech to a time prior to a preset time.

16. The control method according to claim 9, wherein the determining the signal characteristic comprises displaying, in real-time, information of the signal characteristic of the voice signal that is generated from the speech.

17. An image processing apparatus comprising:
a voice input interface which is configured to receive a voice input;
a storage which is configured to store a plurality of user accounts, and for each user account, signal characteristic information of a voice signal that corresponds to the user account; and
a controller which is configured to, in response to the voice input interface receiving a voice input through the voice input interface, determines a signal characteristic of the voice input, select a user account from among the plurality of user accounts based on the signal characteristic, and automatically log in to the selected user account.

18. The image processing apparatus of claim 17, wherein the voice input is received in response to a log-in event.

19. The image processing apparatus of claim 18, wherein in response to the log-in event, the controller is configured to request input of a plurality of voice inputs, and determine the signal characteristic using the plurality of voice inputs.
